(19) United States
(12) Patent Application Publication
(10) Pub. No.: US 2026/0285763 A1
(43) Pub. Date: Sep. 24, 2026

(54) CASTABLE REFRACTORY COMPOSITIONS AND MANUFACTURING METHODS

(71) Applicant: Calderys France, Sezanne (FR)

(72) Inventor: Cheng-Hsien SUN, Gaoshu Township, Pingtung County (TW)

(73) Assignee: Calderys France, Sezanne (FR)

(21) Appl. No.: 18/996,065

(22) PCT Filed: Jul. 21, 2023
(86) PCT No.: PCT/EP2023/070341

§ 371 Date: Jan. 17, 2025

(30) Foreign Application Priority Data
Jul. 21, 2022 (TW) 111127378

(51) Int. Cl. C04B 35/20; C04B 35/63; C04B 35/80

(52) U.S. Cl. CPC C04B 35/20; C04B 35/6303; C04B 35/80; C04B 2235/3206; C04B 2235/3217; C04B 2235/3445; C04B 2235/602; C04B 2235/606

(57) ABSTRACT

A manufacturing method of accessories by basic refractory in steel tundish includes steps of preparation, mixing, mold filling and forming. The mixing step is to mix dead burned magnesian sand, olivine sand, and bonding agent that are prepared in the preparation step according to a specific ratio to obtain a castable refractory composition. The mold filling step is to mix the castable refractory composition and water according to a specific ratio and fill into a mold for forming. Finally, the forming step is to demould and dry to obtain the refractory unit. A castable refractory composition comprising 30-50% by weight of dead-burned magnesian sand, 40-60% by weight of olivine sand, and 2.5-10% by weight of bonding agent is made.

### TECHNICAL FIELD

The present invention relates to castable refractory compositions, molded refractory units, sintered refractory units and associated manufacturing methods and uses, and in particular to a manufacturing method of accessories by basic refractory in steel tundish.

### RELATED ART

It is known that a steel tundish is an indispensable important container in the continuous casting process of molten steel. The steel tundish is mainly used to stabilize the flow of molten steel, and to achieve the functions of splitting the flow and ensuring continuous casting of molten steel with uninterrupted flow. A refractory unit, such as a slag retaining wall, etc., is typically provided within the steel tundish. The refractory unit is used to uniform the temperature of molten steel, change the flow direction of molten steel, and facilitate the floating, collision, and aggregation of inclusions, thereby reducing the incorporation of inclusions into the steel billet, bloom or slab, thereby improving the cleanliness of molten steel. As the refractory unit needs to be immersed in high-temperature molten steel for a long time, it must have good bearing capacity and erosion-resistant capacity.

At present, the common refractory units are mainly made of aluminosilicate. However, after actual use, it is found that the aforementioned aluminosilicate units are easily eroded by the slag in the steel tundish, so that inclusions are easily formed by the aluminosilicate unit in the operation process to be incorporated into the cast steel (e.g., the steel billet, bloom or slab). This causes pollution of molten steel by the aluminosilicate unit and leads to the defect of poor cleanliness of molten steel. When the aluminosilicate units are directly subjected to scouring from high-temperature molten steel and strong thermal stress, they are more likely to be deformed, perforated, cracked or collapsed, which really needs to be improved.

### SUMMARY

An object of the present invention is to improve the bearing capacity and erosion-resistant capacity of refractory units. Another object of the present invention is to provide refractory units which can effectively absorb impurities such as alumina particles, thereby improving the cleanliness of molten steel.

Another object is to provide a manufacturing method of accessories by basic refractory in steel tundish, which greatly improves the bearing capacity and erosion-resistant capacity of the magnesian refractory unit, and the magnesian refractory unit can effectively absorb aluminum, thereby improving the cleanliness of molten steel.

According to a first aspect, a castable refractory composition comprises 30-50% by weight of dead-burned magnesian sand, 40-60% by weight of olivine sand, and 2.5-10% by weight of bonding agent. It will be appreciated that the total weight of the castable refractory composition is not more than 100% by weight.

The castable refractory composition may comprise 35-45%, or 37-43%, or 40-50%, or 40-45%, or 45-50%, by weight dead-burned magnesian sand. Dead-burned magnesian sand may also be known as dead-burned magnesia or dead-burned magnesite (i.e. dead-burned MgO). The dead-burned magnesian sand may have a purity of no less than about 90 wt. % MgO. The dead-burned magnesian sand may have a particle size of no greater than 400 mesh, or no greater than 200 mesh. The dead-burned magnesian sand may have a particle size of no less than 10 mesh, or no less than 14 mesh.

The castable refractory composition may comprise 40-50% by weight olivine sand, for example, 42-48% by weight olivine sand. The olivine sand may have a particle size no greater than about 10 mm, for example, no greater than about 5 mm. The olivine sand may have a particle size no less than about 500 μm, for example, no less than about 1 mm.

The castable refractory composition may comprise 2.5-7.5% by weight of bonding agent or 5-10% by weight of bonding agent. The bonding agent may be a hydraulic bonding agent, a chemical bonding agent, an organic bonding agent, an adhesive bonding agent or a ceramic bonding agent. The bonding agent may be a cement-based bonding agent or a cement-free bonding agent. The bonding agent may be a magnesium based bonding agent (e.g. magnesium sulfate or magnesium phosphate), a calcium based bonding agent (e.g. calcium aluminate), a sodium based bonding agent (e.g. sodium silicate), a potassium based bonding agent (e.g. potassium silicate) or an aluminum based bonding agent (e.g. aluminum phosphate or aluminum sulfate). The bonding agent may be or comprise a phosphate (e.g. magnesium phosphate or aluminum phosphate), a sulfate (e.g. magnesium sulfate) or a silicate (e.g. potassium silicate or sodium silicate). In some examples, the bonding agent is magnesium sulfate. In some examples, the bonding agent is silica fume. In some examples, the bonding agent comprises aluminum sulfate, boric acid and citric acid.

The castable refractory composition may comprise a peptizing agent. A peptizing agent may also be known as a dispersant or a deflocculating agent. The peptizing agent may help break up and/or disperse particles when the castable refractory composition is mixed with water in a molding process. Therefore, use of peptizing agent may enable micro powder to be effectively broken up in a mixing process, and tiny particles may be filled into pores by the mixing process, thereby reducing the surface pores of a resultant refractory unit. This may not only greatly improve the bearing capacity and erosion-resistant capacity of the refractory unit, but may also enable the magnesian refractory unit to effectively absorb aluminum in the operation process, thereby improving the cleanliness of molten steel. The peptizing agent may be a sulfate, such as magnesium sulfate, or a phosphate, such as sodium hexametaphosphate. The castable refractory composition may comprise less than 1% by weight, for example, less than 0.5% by weight of the peptizing agent. In some examples, the castable refractory composition comprises no less than about 0.01%, for example, 0.01-1%, or 0.01-0.5% by weight of the peptizing agent. In other examples, the castable refractory composition is essentially free of peptizing agent. For example, the castable refractory composition may comprise no more than about 0.01%, for example, no more than about 0.005% by weight, of peptizing agent.

In some examples, the bonding agent may function as a peptizing agent. For example, magnesium sulfate may function as both a bonding agent and a peptizing agent. In such examples, it may be that only a portion of the bonding agent functions as a peptizing agent. For example, it may be that a sufficient portion of the bonding agent functions as a peptizing agent such that the overall composition can be considered to contain less than 1% by weight of peptizing agent.

The castable refractory composition may comprise an anti-hydration agent. The anti-hydration agent may serve to coat particles of the castable refractory composition to reduce (e.g. prevent) water absorption. In particular, the anti-hydration agent may serve to reduce water absorption by MgO. The anti-hydration agent may be a carboxylic acid (such as oleic acid, stearic acid, citric acid or lactic acid) or a salt thereof. For example, the anti-hydration agent may be a lactate such as aluminum lactate. The castable refractory composition may comprise less than 1% by weight, for example, less than 0.5% by weight of the anti-hydration agent. In some examples, the castable refractory composition comprises no less than about 0.01%, for example, 0.01-1%, or 0.01-0.5% by weight of the anti-hydration agent. In other examples, the castable refractory composition is essentially free of anti-hydration agent. For example, the castable refractory composition may comprise no more than about 0.01%, for example, no more than about 0.005% by weight, of anti-hydration agent.

The castable refractory composition may further comprise one or more refractory aggregate materials in addition to the dead-burned magnesian sand and olivine sand. The one or more refractory aggregate materials may comprise one or more of alumina, bauxite, spinel, granite, basalt, emery, chamotte, molochite, sillimanite, gibbsite, vermiculite, diatomite, perlite, and so on. For example, the one or more refractory aggregate materials may comprise alumina, bauxite, and/or spinel. The alumina may be reactive alumina or semi-reactive alumina. The castable refractory composition may comprise no more than about 20% by weight or no more than about 10% by weight of said one or more refractory aggregate materials. The castable refractory composition may comprise no less than about 1% by weight or no less than about 5% by weight of said one or more refractory aggregate materials. The castable refractory composition may comprise 1-20% by weight, for example, 1-10% by weight, or 5-10% by weight, of said one or more refractory aggregate materials.

The castable refractory composition may further comprise one or more additives in addition to the peptizing agent and/or anti-hydration agent described hereinabove. For example, the castable refractory composition may comprise one or more drying aids, for example, fibers such as organic fibers and/or metallic fibers which may melt, decompose and/or react at temperatures below about 150° C. or below about 100° C. It will be appreciated that fibers can assist in achieving a crack-free heat-up of refractory materials. After melting and/or decomposing of the fibers, a network of pores may remain to facilitate the transport and evaporation of water from the refractory (e.g., from the MgO).

Aluminum oxide (Al₂O₃) contained in the castable refractory composition may be less than 10% by weight. The castable refractory composition may comprise magnesium oxide (MgO) 45 to 75%, silicon dioxide (SiO₂) 25 to 35%, aluminum oxide (Al₂O₃)<8%, ferric oxide (Fe₂O₃)<5% and calcium oxide (CaO)≤1.5%.

The castable refractory composition may be a basic (i.e., alkaline) refractory composition.

According to a second aspect, a method of manufacturing a refractory unit comprises the steps of preparation, mixing, mold filling and forming in sequence; wherein in the preparation step, dead-burned magnesian sand, olivine sand, and a bonding agent are provided; in the mixing step, 30 to 50% by weight of the dead-burned magnesian sand, 40 to 60% by weight of the olivine sand, and 2.5 to 10% by weight of the bonding agent are mixed to obtain a castable refractory composition; in the mold filling step, the aforementioned castable refractory composition and 5 to 10% by weight of water are poured into the mold; and in the forming step, demoulding and drying are performed to obtain the refractory unit.

The castable refractory composition may have any of the characteristics (e.g. components and relative amounts thereof) described hereinabove in relation to the first aspect.

The mixing step may involve uniformly mixing the components together to obtain the castable refractory composition.

Drying of the refractory unit may be carried out at a temperature greater than 300° C. After drying, the refractory unit may be sintered. Sintering of the refractory unit may be carried out at a temperature greater than 1300° C.

The refractory unit may be a refractory unit for use in a tundish for steelmaking. For example, the refractory unit may be a retaining wall (e.g. a dam or a weir), a flow nozzle or a square brick. The refractory unit may be known as a magnesian refractory unit.

According to a third aspect, the manufacturing method of accessories by basic refractory in steel tundish of the present invention comprises the steps of preparation, mixing, mold filling and forming in sequence; wherein in the preparation step, dead-burned magnesian sand, olivine sand, a bonding agent, a peptizing agent, and an anti-hydration agent are provided; in the mixing step, 30 to 50% by weight of the dead-burned magnesian sand, 40 to 60% by weight of the olivine sand, 5 to 10% by weight of the bonding agent, less than 1% by weight of the peptizing agent, and less than 1% by weight of the anti-hydration agent are uniformly mixed to obtain a magnesian castable refractory, where aluminum oxide (Al₂O₃) contained in the magnesian castable refractory is less than 10% by weight; in the mold filling step, a mold is provided to pour the aforementioned magnesian castable refractory and 5 to 10% by weight of water into the mold for forming; and in the forming step, demoulding and drying are performed to obtain the magnesian refractory unit.

Thus, particles are coated with the anti-hydration agent, micro powder is effectively broken up with the peptizing agent in the mixing process, and the tiny particles are filled into pores by the mixing process, thereby reducing the surface pores of the magnesian refractory unit, which not only greatly improves the bearing capacity and erosion-resistant capacity of the magnesian refractory unit, but also enables the magnesian refractory unit to effectively absorb aluminum in the operation process, thereby improving the cleanliness of molten steel.

According to a fourth aspect, there is provided a molded refractory unit obtained or obtainable by the method according to the second aspect or the third aspect. The molded refractory unit may have been dried (i.e., it may be a dried refractory unit) but it has not typically been sintered. The molded refractory unit may be ready for use, for example, in a tundish in steelmaking.

According to a fifth aspect, there is provided a sintered refractory unit obtained or obtainable by sintering the molded refractory unit according to the fourth aspect. The sintered refractory unit may be ready for use, for example, in a tundish in steelmaking.

According to a sixth aspect, there is provided a use of the molded refractory unit according to the fourth aspect or the sintered refractory unit according to the fifth aspect as a refractory accessory, such as a slag retaining wall, in a tundish during steelmaking to improve the cleanliness of molten steel. Use of the molded refractory unit or sintered refractory unit may improve the cleanliness of the molten steel relative to molten steel processed in a tundish using a corresponding refractory unit made of a different refractory composition not according to the present invention. The molded refractory unit or sintered refractory unit may be used to absorb impurities such as alumina from the steel.

In accordance with the third aspect, there is provided the subject-matter set out in the following numbered paragraphs:

1. A manufacturing method of accessories by basic refractory in steel tundish, comprising:
a preparation step, in which dead-burned magnesian sand, olivine sand, a bonding agent, a peptizing agent, and an anti-hydration agent are provided;
a mixing step, in which 30-50% by weight of the dead-burned magnesian sand, 40-60% by weight of the olivine sand, 5-10% by weight of the bonding agent, less than 1% by weight of the peptizing agent, and less than 1% by weight of the anti-hydration agent are uniformly mixed to obtain magnesian castable refractory, where aluminum oxide (Al₂O₃) contained in the magnesian castable refractory is less than 10% by weight, so that particles are coated with the anti-hydration agent, micro powder is broken up with the peptizing agent in the mixing process, and the tiny particles are filled into pores by the mixing process, thereby reducing surface pores;
a mold filling step, in which a mold is provided to pour the magnesian castable refractory and 5-10% by weight of water into the mold for forming; and
a forming step, in which demoulding is performed for the mold to obtain a magnesian refractory unit, and the magnesian refractory unit is allowed to stand and dried to be installed in the steel tundish for use.

2. The manufacturing method of accessories by basic refractory in steel tundish according to paragraph 1, wherein the main chemical composition of the magnesian castable refractory is magnesium oxide (MgO) 45 to 75%, silicon dioxide (SiO₂) 25 to 35%, aluminum oxide (Al₂O₃)<8%, ferric oxide (Fe₂O₃)<5% and calcium oxide (CaO)≤1.5%.

3. The manufacturing method of accessories by basic refractory in steel tundish according to paragraph 1, wherein the magnesian refractory unit can be a retaining wall, a flow nozzle or a square brick.

The skilled person will appreciate that, except where mutually exclusive, a feature described in relation to any one of the above aspects may be applied mutatis mutandis to any other aspect. Furthermore, except where mutually exclusive, any feature described herein may be applied to any aspect and/or combined with any other feature described herein.

### BRIEF DESCRIPTION OF THE DRAWINGS

FIG. 1 is a schematic block diagram of a preferred embodiment of the present invention.

FIG. 2 shows images of a magnesian refractory unit according to an example embodiment of the invention.

### DETAILED DESCRIPTION

The forgoing and other technical contents, features and effects of the present invention will be apparent from the following detailed description of preferred embodiments with reference to the drawings.

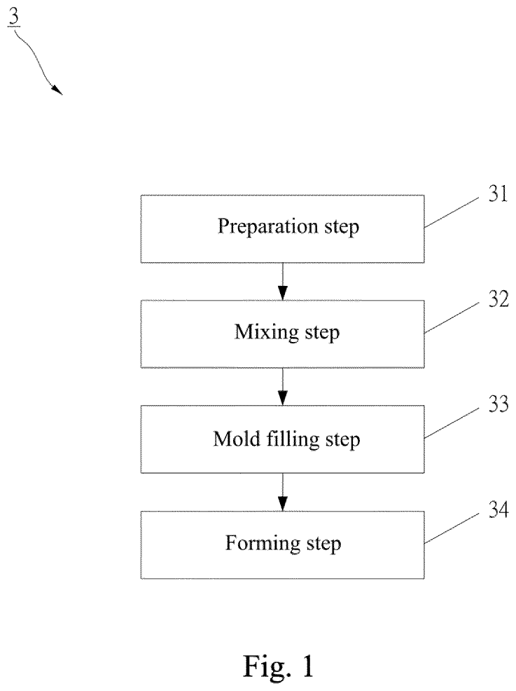

As shown in FIG. 1, an example embodiment of the manufacturing method of accessories by basic refractory in steel tundish 3 of the present invention comprises a preparation step 31, a mixing step 32, a mold filling 33, and a forming step 34; wherein in the preparation step 31, dead-burned magnesian sand, olivine sand, a bonding agent, a peptizing agent, and an anti-hydration agent were provided; in the mixing step 32, 49% by weight of the dead-burned magnesian sand, 45% by weight of the olivine sand, 5% by weight of the bonding agent, less than 1% by weight of the peptizing agent, and less than 1% by weight of the anti-hydration agent were uniformly mixed to obtain 100% by weight of magnesian castable refractory, where aluminum oxide (Al₂O₃) contained in the magnesian castable refractory is less than 10% by weight such that the chemical composition in proportions of the magnesian castable refractory is magnesium oxide (MgO) 45 to 75%, silicon dioxide (SiO₂) 25 to 35%, aluminum oxide (Al₂O₃)<8%, ferric oxide (Fe₂O₃)<5% and calcium oxide (CaO)≤1.5%.

Next, in the mold filling step 33, a mold was provided, where the shape of the mold can be adjusted according to the shape of the unit to be formed, and then the magnesian castable refractory obtained in the mixing step 32 and 6.2% by weight of water are mixed and poured into the mold so that the magnesian castable refractory and water are mixed and formed. Finally, in the forming step 34, demoulding was performed for the aforementioned mold to obtain a magnesian refractory unit after removing the mold.

The magnesian refractory unit can be an accessory that needs to be provided in the steel tundish and in contact with molten steel, such as a retaining wall, a flow nozzle or a square brick, etc., and the magnesian refractory unit can be installed in the steel tundish for use after it is dried.

In the example embodiment in which the refractory composition included peptizing agent and anti-hydration agent, micro powder (having a d₅₀ of about 2 μm) is effectively broken up with the peptizing agent in the mixing process, particles are completely coated with the anti-hydration agent, and the tiny particles (having a particle size of about 0.1 mm) are filled into pores by the mixing process, thereby reducing the surface pores of the magnesian refractory unit after forming, so that the erosion-resistant capacity of the magnesian refractory unit is greatly improved. In addition, the magnesian refractory unit will not have cracks after drying, and the demoulding is smooth, with good workability and strength. Furthermore, through tests and assessments as well as pre-casting, filling and forming, massive production of the magnesian refractory unit can be feasible, thereby further enhancing the market competitiveness. Moreover, the magnesian refractory unit can be hung and installed after it is completed, and can be used in very good condition.

The magnesian refractory unit was subjected to a rupture test (M.O.R) and a compression test (C.C.S) after it was completed. The results show that the rupture test is >7.0 N/mm², and the compression test is >30.0 N/mm², that is, the magnesian refractory unit has high initial strength.

After the crucible test of the magnesian refractory unit, the results show that its erosion rate is 2.1%, and the permeability is 8.9%. The aforementioned results are better than the crucible test results (erosion rate 18.9%, permeability 16.1%) of the conventional aluminosilicate refractory unit, indicating that the magnesian refractory unit has better erosion-resistant capacity and anti-penetration capacity.

In the hydration test, the magnesian refractory unit was completely immersed in water, and after being covered, it was left at a constant temperature of 80° C. for 240 hours. The results show that the weight increase rate of the magnesian refractory unit is 2.3%, the rupture test increases by 3.7%, and the compressive test increases by 16.4%, and the magnesian refractory unit has no crack after the hydration test, that is, the magnesian refractory unit has good anti-hydration capacity and is very stable. In addition, after the magnesian refractory unit was dried at 110° C. for 24 hours, it was stored at room temperature for 40 days, with no obvious change in strength. The test results are as follows:

| | Rupture Test | Compression Test |
|---|---|---|
| | (M.O.R) (N/mm²) | (C.C.S) (N/mm²) |
| 1 day | 7.3 | 34.9 |
| 10 days | 7.1 | 36.9 |
| 20 days | 6.7 | 34.8 |
| 30 days | 7.4 | 35.5 |
| 40 days | 7.5 | 35.7 |

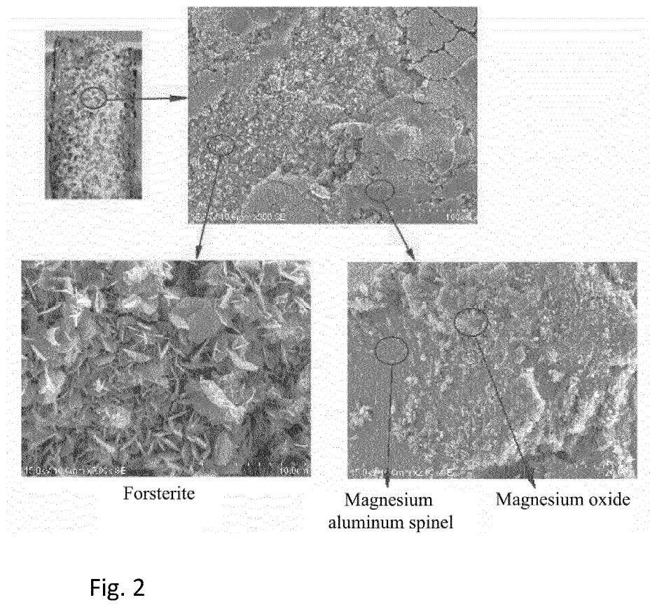

An enlarged picture of the magnesian refractory unit is shown in FIG. 2. The residual mass ingredients and compositional analysis of the magnesian refractory unit are as follows:

XRF

| Slag line area | | Molten steel area | |
|---|---|---|---|
| | Content | | Content |
| Name | (%) | Name | (%) |
| Magnesium oxide (MgO) | 60.92 | Magnesium oxide (MgO) | 55.79 |
| Aluminum oxide (Al₂O₃) | 11.87 | Aluminum oxide (Al₂O₃) | 9.02 |

XRD

| | |
|---|---|
| Slag line area | Molten steel area |

| | Content | | Content |
|---|---|---|---|
| Phase name | (%) | Phase name | (%) |
| Spinel | 16.5 | Spinel | 12.5 |
| Forsterite | 45.5 | Forsterite | 40.0 |
| Periclase | 33.5 | Periclase | 32.5 |
| Amorphous phase | 4.50 | Amorphous phase | 15.0 |
| Sum | 100 | Sum | 100 |

It can be seen from the above that before use, the magnesian refractory unit initially contains less than 8% by weight of aluminum oxide (Al₂O₃), but the aluminum oxide (Al₂O₃) contents in both the slag line area and the molten steel area are higher than 8% by weight, which further proves that the magnesian refractory unit can effectively absorb aluminum (Al) in the operation process and magnesium aluminum spinel (MgAl₂O₄) is formed, as shown in the aforementioned enlarged picture. In addition, the incorporation of inclusions into the steel billet is greatly reduced, thereby further improving the cleanliness of molten steel, and the magnesian refractory unit has good erosion-resistant capacity and bearing capacity. Moreover, the magnesian refractory unit can be effective in reducing the defect rate of steel products. Although the cost of the magnesian refractory unit is slightly higher, the thickness of the magnesian refractory unit can be decreased, to further reduce the overall cost while maintaining sufficient bearing capacity and erosion-resistant capacity, thereby increasing market competitiveness.

To sum up, according to the manufacturing method of accessories by basic refractory in steel tundish of the present invention, in the preparation step, dead-burned magnesian sand, olivine sand, and a bonding agent, an optional peptizing agent, and an optional anti-hydration agent are provided; in the mixing step, 30 to 50% by weight of the dead-burned magnesian sand, 40 to 60% by weight of the olivine sand, and 2.5 to 10%, for example, 5 to 10%, by weight of the bonding agent, less than 1% by weight of the optional peptizing agent, and less than 1% by weight of the optional anti-hydration agent are uniformly mixed to obtain magnesian castable refractory, where aluminum oxide (Al₂O₃) contained in the magnesian castable refractory is less than 10% by weight; in the mold filling step, a mold is provided to mix the aforementioned magnesian castable refractory and 5 to 10% by weight of water to be poured into the mold for forming; and finally in the forming step, demoulding and drying are performed to obtain a magnesian refractory unit. In this way, the erosion-resistant capacity of the magnesian refractory unit is greatly improved, and the magnesian refractory unit has better bearing capacity. Meanwhile, the magnesian refractory unit can effectively absorb aluminum in the operation process, thereby further improving the cleanliness of molten steel.

However, the above description only gives the preferred embodiments of the present invention, and is not intended to limit the scope of the present invention, and all simple equivalent changes and modifications made according to the claims of the present invention and the contents of the description of the present invention should still fall within the scope covered by the claims of the present invention.

### DESCRIPTION OF SYMBOLS

### This Invention

3: Manufacturing method of accessories by basic refractory in steel tundish
31: Preparation step
32: Mixing step
33: Mold filling step
34: Forming step

1. A castable refractory composition comprising 30-50% by weight of dead-burned magnesian sand, 40-60% by weight of olivine sand, and 2.5-10% by weight of bonding agent.

2. The castable refractory composition according to claim 1, wherein the castable refractory composition comprises 5-10% by weight of bonding agent.

3. The castable refractory composition according to claim 1, wherein the castable refractory composition comprises peptizing agent and/or anti-hydration agent, for example, and
wherein the castable refractory composition comprises less than 1% by weight of the peptizing agent and/or less than 1% by weight of the anti-hydration agent.

4. The castable refractory composition according to claim 1, wherein the castable refractory composition further comprises one or more refractory aggregate materials, and
wherein the castable refractory composition further comprises no more than 20% by weight of said one or more refractory aggregate materials.

5. The castable refractory composition according to claim 1, wherein the castable refractory composition further comprises one or more drying aids.

6. A method of manufacturing a refractory unit, comprising:
a preparation step, in which dead-burned magnesian sand, olivine sand, and a bonding agent are provided;
a mixing step, in which 30-50% by weight of the dead-burned magnesian sand, 40-60% by weight of the olivine sand, and 2.5-10% by weight of the bonding agent are mixed to obtain a castable refractory composition;
a mold filling step, in which the castable refractory composition and 5-10% by weight of water are poured into a mold; and
a forming step, in which demoulding is performed to remove a refractory unit from the mold, and the refractory unit is dried.

7. The method according to claim 6, wherein the castable refractory composition comprises 5-10% by weight of the bonding agent.

8. The method according to claim 6, wherein the castable refractory composition comprises peptizing agent and/or anti-hydration agent, and
wherein the castable refractory composition comprises less than 1% by weight of the peptizing agent and/or less than 1% by weight of the anti-hydration agent.

9. The method according to claim 6, wherein the castable refractory composition further comprises one or more refractory aggregate materials, wherein the castable refractory composition further comprises no more than about 20% by weight or no more than about 10% by weight of said one or more refractory aggregate materials.

10. The method according to claim 6, wherein the castable refractory composition further comprises one or more drying aids.

11. The method according to claim 6, wherein aluminum oxide (Al₂O₃) contained in the castable refractory composition is less than 10% by weight.

12. The method according to claim 6, wherein the refractory unit is a retaining wall, a flow nozzle or a square brick.

13. A molded refractory unit obtained by the method according to claim 6.

14. A sintered refractory unit obtained by sintering the molded refractory unit according to claim 13.

15. (canceled)

16. A manufacturing method of accessories by basic refractory in steel tundish, comprising:
a preparation step, in which dead-burned magnesian sand, olivine sand, a bonding agent, a peptizing agent, and an anti-hydration agent are provided;
a mixing step, in which 30-50% by weight of the dead-burned magnesian sand, 40-60% by weight of the olivine sand, 5-10% by weight of the bonding agent, less than 1% by weight of the peptizing agent, and less than 1% by weight of the anti-hydration agent are uniformly mixed to obtain magnesian castable refractory, where aluminum oxide (Al₂O₃) contained in the magnesian castable refractory is less than 10% by weight, so that particles are coated with the anti-hydration agent, micro powder is broken up with the peptizing agent in the mixing process, and the tiny particles are filled into pores by the mixing process, thereby reducing surface pores;
a mold filling step, in which a mold is provided to pour the magnesian castable refractory and 5-10% by weight of water into the mold for forming; and
a forming step, in which demoulding is performed for the mold to obtain a magnesian refractory unit, and the magnesian refractory unit is allowed to stand and dried to be installed in the steel tundish for use.

17. The manufacturing method of accessories by basic refractory in steel tundish according to claim 16, wherein the main chemical composition of the magnesian castable refractory is magnesium oxide (MgO) 45 to 75%, silicon dioxide (SiO₂) 25 to 35%, the aluminum oxide (Al₂O₃)<8%, ferric oxide (Fe₂O₃)<5% and calcium oxide (CaO)≤1.5%.

18. The manufacturing method of accessories by basic refractory in steel tundish according to claim 16, wherein the magnesian refractory unit is a retaining wall, a flow nozzle or a square brick.

19. The castable refractory composition according to claim 4, wherein the castable refractory composition further comprises no more than 10% by weight of said one or more refractory aggregate materials.

20. The castable refractory composition according to claim 5, wherein the one or more drying aids include fiber.

21. The castable refractory composition according to claim 4, wherein the one or more refractory aggregate materials are selected from the group consisting of alumina, bauxite, and spinel.

22. The method according to claim 9, wherein the castable refractory composition further comprises no more than 10% by weight of said one or more refractory aggregate materials.

23. The method according to claim 10, wherein the one or more drying aids include fiber.

24. The method according to claim 9, wherein the one or more refractory aggregate materials are selected from the group consisting of alumina, bauxite, and spinel.

25. The method according to claim 11, wherein the castable refractory composition comprises magnesium oxide (MgO) 45 to 75%, silicon dioxide (SiO₂) 25 to 35%, the aluminum oxide (Al₂O₃)<8%, ferric oxide (Fe₂O₃)<5% and calcium oxide (CaO)≤1.5%.
